(19) United States
(12) Patent Application Publication
(10) Pub. No.: US 2022/0126874 A1
(43) Pub. Date: Apr. 28, 2022

(54) Autonomous Driving Control Apparatus and Method

(71) Applicants: Hyundai Motor Company Seoul, Seoul (KR); Kia Corporation, Seoul (KR)

(72) Inventor: Tae Dong Oh, Seoul (KR)

(21) Appl. No.: 17/470,576

(22) Filed: Sep. 9, 2021

(30) Foreign Application Priority Data
Oct. 28, 2020 (KR) 10-2020-0141305

(51) Int. Cl. B60W 60/00

(52) U.S. Cl. CPC B60W 60/0027; B60W 2554/4045; B60W 2520/10; B60W 2520/12; B60W 2554/4042; B60W 2554/4043; B60W 2554/802; B60W 2520/125; B60W 2554/4041; B60W 2554/4044; B60W 2555/60; B60W 2552/00; B60W 2554/801; B60W 2520/105

(57) ABSTRACT

An autonomous driving control method includes collecting travel information on a host vehicle traveling autonomously and on at least one other vehicle, determining a driving intention of the other vehicle based on the travel information on the other vehicle, predicting a driving route of the other vehicle based on the driving intention of the other vehicle, and determining a driving route of the host vehicle based on the predicted driving route of the other vehicle.

### CROSS-REFERENCE TO RELATED APPLICATIONS

This application claims the benefit of Korean Patent Application No. 10-2020-0141305, filed on Oct. 28, 2020, which is hereby incorporated by reference as if fully set forth herein.

### TECHNICAL FIELD

The present invention relates to an autonomous driving control apparatus and method.

### BACKGROUND

In general, an autonomous vehicle is a vehicle that is capable of autonomously travelling to a destination by itself while identifying the conditions of a road and surroundings without manipulation of an accelerator pedal, a steering wheel, a brake pedal, or the like by a driver.

A conventional autonomous vehicle uses information about the position and dynamics of another vehicle to calculate the predicted route of the other vehicle, and identifies the predicted route based on a precise map to output the driving route of the other vehicle.

However, because vehicles actually traveling on the road need to change the driving routes thereof according to the driving conditions and the driving intention of neighboring vehicles and the current state of traffic signals, a driving route of another vehicle predicted based only on information about positions and dynamics may be different from the actual driving route thereof. Therefore, when a vehicle autonomously travels along a route predicted by a conventional method during congested or crowded road conditions, it is difficult to maintain the autonomous driving state due to the frequent occurrence of false alarms and alarm failure.

### SUMMARY

The present invention relates to an autonomous driving control apparatus and method. Particular embodiments relate to an autonomous driving control apparatus and method capable of determining the driving intention of another vehicle so as to respond to various traffic environments during autonomous driving.

Accordingly, embodiments of the present invention provide an autonomous driving control apparatus and method that substantially obviate one or more problems due to limitations and disadvantages of the related art.

An embodiment of the present invention provides an autonomous driving control apparatus and method capable of improving the accuracy of prediction of a driving route of a neighboring vehicle in various traffic environments.

In particular, an embodiment of the present invention provides an autonomous driving control apparatus and method capable of predicting the driving routes of neighboring vehicles through analysis of the distance between other vehicles present in a search area, the traffic flow thereof, the dynamic characteristics thereof, and infrastructure information and through determination of the driving intention of the vehicles based on the interaction between the vehicles.

However, the embodiments of the present invention are not limited to the above-mentioned embodiments, and other embodiments not mentioned herein will be clearly understood by those skilled in the art from the following description.

An autonomous driving control method according to an embodiment of the present invention may include collecting travel information on a host vehicle traveling autonomously and travel information on at least one other vehicle, determining a driving intention of the other vehicle based on a result of applying a predetermined index to the travel information on the other vehicle, predicting a driving route of the other vehicle based on the driving intention of the other vehicle, and determining a driving route of the host vehicle based on the predicted driving route of the other vehicle.

In addition, an autonomous driving control apparatus according to an embodiment of the present invention may include a first determiner configured to collect travel information on a host vehicle traveling autonomously and travel information on at least one other vehicle present near the host vehicle to determine a traffic environment, a second determiner configured to determine a driving intention of a vehicle of interest traveling directly ahead of the host vehicle in the same lane as the host vehicle based on the travel information on the other vehicle, and a driving controller configured to predict a driving route of the other vehicle based on a driving intention of the other vehicle and the travel information on the other vehicle and to determine a driving route of the host vehicle based on the predicted driving route of the other vehicle.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principle of embodiments of the invention. In the drawings:

FIG. 1 is a schematic block diagram of an autonomous driving control apparatus according to an embodiment of the present invention;

FIG. 2 is a schematic block diagram showing an example of the configuration of the other-vehicle determiner shown in FIG. 1;

FIG. 3 is a control flowchart of the other-vehicle determiner according to an embodiment of the present invention;

FIGS. 4A, 4B, 5A, and 5B are diagrams for explaining an in-lane extra space determination method according to an embodiment of the present invention;

FIG. 6 is a diagram for explaining an infrastructure-based determination method according to an embodiment of the present invention;

FIGS. 7A and 7B are diagrams for explaining an other-vehicle deflection value determination method according to an embodiment of the present invention;

FIGS. 8A and 8B are diagrams for explaining an other-vehicle heading direction determination method according to an embodiment of the present invention;

FIGS. 9 to 12 are diagrams for explaining a method of determining the driving intention of another vehicle according to an embodiment of the present invention; and

FIGS. 13 and 14 are diagrams for explaining a method of controlling a host vehicle based on the driving intention of another vehicle according to an embodiment of the present invention.

### DETAILED DESCRIPTION OF ILLUSTRATIVE EMBODIMENTS

Hereinafter, embodiments of the present invention will be described in detail with reference to the accompanying drawings so that those skilled in the art may easily carry out the embodiments. The present invention may, however, be embodied in many different forms, and should not be construed as being limited to the embodiments set forth herein. In the drawings, parts irrelevant to the description of embodiments of the present invention will be omitted for clarity. Like reference numerals refer to like elements throughout the specification.

Throughout the specification, when a certain part “includes” or “comprises” a certain component, this indicates that other components are not excluded, and may be further included unless otherwise noted. The same reference numerals used throughout the specification refer to the same constituent elements.

An autonomous driving control apparatus according to embodiments of the present invention analyzes a driving strategy of another vehicle, which is determined in consideration of the distance between neighboring vehicles, the driving intention of the neighboring vehicles, the vehicle speed, the presence or absence of a dangerous vehicle, and surrounding infrastructure, and predicts the driving strategies of all the vehicles present in a predetermined search area based thereon. The autonomous driving control apparatus determines, based on the predicted driving strategy of another vehicle, a route that a host vehicle needs to select for smooth travel when controlling driving of the host vehicle, selects a driving strategy for entering the corresponding lane, and controls driving of the host vehicle. In this way, since the autonomous driving of the host vehicle is controlled based on the driving intention of another vehicle, it is possible to variably apply a risk determination criterion in consideration of the driving intention of the other vehicle, thereby reducing the occurrence of false alarms and alarm failure and reducing the occurrence of unnecessary stopping or deceleration of the host vehicle, which may occur due to non-consideration of the future position of the other vehicle. In addition, it is possible to respond to a preceding vehicle that changes lanes and to enable optimal driving control of the host vehicle based on the driving intention of other vehicles in various traffic environments, for example, a complicated traffic situation in which two or more vehicles change lanes at the same time.

Hereinafter, a vehicle driving control apparatus associated with embodiments of the present invention will be described with reference to the accompanying drawings. First, the main terms used in this specification and the drawings will now be described.

Host vehicle: Subject vehicle

Another vehicle: Vehicle other than the host vehicle

Neighboring vehicle: Vehicle other than the host vehicle that is detected by a sensor mounted in the host vehicle

Preceding vehicle: Neighboring vehicle that is traveling directly ahead of the host vehicle

Driving lane: Lane in which the host vehicle is currently traveling

Target lane: Lane that the host vehicle intends to enter

Target lane vehicles: Neighboring vehicles that are traveling in the target lane

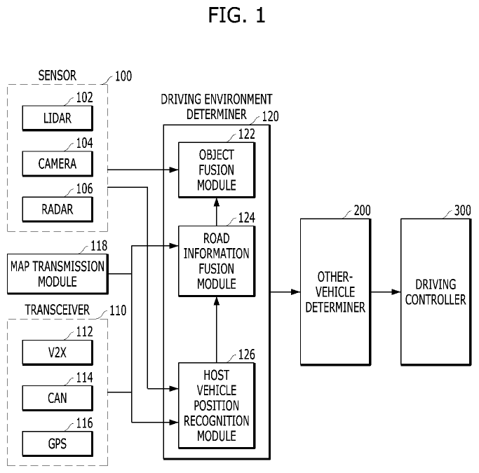

FIG. 1 is a schematic block diagram of an autonomous driving control apparatus according to an embodiment of the present invention.

Referring to FIG. 1, an autonomous driving control apparatus according to an embodiment of the present invention includes a sensor 100, a transceiver 110, a map transmission module 118, a driving environment determiner 120, an other-vehicle determiner 200, and a driving controller 300.

The sensor 100 may sense one or more neighboring vehicles located ahead of, beside, or behind the host vehicle, and may detect the position, speed, and acceleration of each of the neighboring vehicles. The sensor 100 may include various sensors, such as a LiDAR 102, a camera 104, and a RaDAR 106, which are mounted to the front side, the lateral side, and the rear side of the host vehicle.

The LiDAR 102 may measure the distance between the host vehicle and a neighboring vehicle. The LiDAR 102 may emit a laser pulse to a neighboring vehicle and may measure the arrival time of the laser pulse reflected from the neighboring vehicle to calculate the spatial positional coordinates of the reflection point, thereby determining the distance to the neighboring vehicle and the shape thereof.

The camera 104 may acquire an image of the surroundings of the host vehicle through an image sensor. The camera 104 may include an image processor for performing image processing, such as noise removal, quality and saturation adjustment, and file compression, on the acquired image.

The RaDAR 106 may measure the distance between the host vehicle and a neighboring vehicle. The RaDAR 106 may emit an electromagnetic wave to a neighboring vehicle and receive the electromagnetic wave reflected from the neighboring vehicle to determine the distance to the neighboring vehicle, the orientation thereof, and the altitude thereof.

The transceiver 110 may receive information for sensing the positions of the host vehicle and a neighboring vehicle. The transceiver 110 may include various devices capable of receiving information for recognizing the position of the host vehicle, such as a vehicle-to-everything (V2X) transceiver 112, a controller area network (CAN) transceiver 114, and a global positioning system (GPS) 116.

The map transmission module 118 provides a precise map in which lanes are discriminable. The precise map may be stored in the form of a database (DB), may be updated automatically and regularly using wireless communication or manually by a user, and may include information about merging sections of lanes (including, for example, position information on the merging sections and legal speed limit information on the merging sections), road information depending on position, information about road branches, and information about intersections.

The driving environment determiner 120 may fuse object information about the host vehicle and other vehicles on a precise map and then output the fused object information based on the information acquired by the sensor 100, the map transmission module 118, and the transceiver 110. The driving environment determiner 120 may include an object fusion module 122, a road information fusion module 124, and a host vehicle position recognition module 126.

The host vehicle position recognition module 126 outputs precise position information on the host vehicle. The host vehicle position recognition module 126 may compare the information sensed by the sensor 100, GPS information on the host vehicle collected by the transceiver 110, and precise map information provided by the map transmission module 118 with each other, and may output the position information on the host vehicle and position recognition reliability information together.

The road information fusion module 124 outputs a precise map on the surroundings of the host vehicle. The road information fusion module 124 outputs precise map information on the surroundings of the host vehicle to the object fusion module 122 based on the position recognition reliability information and the precise map information.

The object fusion module 122 outputs fused object information to the other-vehicle determiner 200. The object fusion module 122 fuses objects onto the precise map based on the information sensed by the sensor 100 and the precise map information on the surroundings of the host vehicle, and then outputs the fused object information.

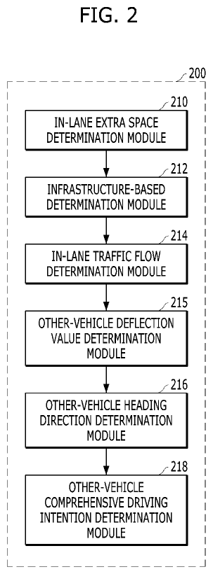

The other-vehicle determiner 200 may receive the information on the objects that have been fused onto the precise map to determine the driving intention of the other vehicle, and the driving controller 300 may determine the driving route of the host vehicle in consideration of the driving intention of the other vehicle output from the other-vehicle determiner 200, and may control the driving of the host vehicle. The other-vehicle determiner 200 may be configured as shown in the block diagram of FIG. 2.

FIG. 2 is a block diagram showing an example of the configuration of the other-vehicle determiner 200 shown in FIG. 1.

The other-vehicle determiner 200 may receive the information on the objects that have been fused onto the precise map, output from the driving environment determiner 120, and may determine the driving intention of the other vehicle.

Referring to FIG. 2, the other-vehicle determiner 200 may include an in-lane extra space determination module 210, an infrastructure-based determination module 212, an in-lane traffic flow determination module 214, an other-vehicle deflection value determination module 215, an other-vehicle heading direction determination module 216, and an other-vehicle comprehensive driving intention determination module 218.

The in-lane extra space determination module 210 outputs an inter-vehicle distance index based on an inter-vehicle distance. The inter-vehicle distance index may be a numerical value, code, or score assigned according to the inter-vehicle distance.

The infrastructure-based determination module 212 determines and outputs a travel index of a vehicle based on the current traffic signal, the remaining time, the next traffic signal (when V2X is available), and a road marking such as a bus stop or a school zone. The travel index of a vehicle may be a numerical value, code, or score assigned according to the extent to which the vehicle can travel without interruption, such as deceleration, stopping, or lane change.

The in-lane traffic flow determination module 214 converts a traffic flow speed in a corresponding lane into an index based on the speed of the vehicle, and outputs the index. The in-lane traffic flow index may be a numerical value, code, or score assigned according to the speeds of vehicles in each lane.

The other-vehicle deflection value determination module 215 outputs an index associated with the degree of deflective travel of another vehicle with respect to the center of the lane in which the other vehicle is traveling. The other-vehicle deflection value index may be a numerical value, code, or score assigned according to the degree of deflection of the other vehicle with respect to the center of the lane in which the other vehicle is traveling.

The other-vehicle heading direction determination module 216 outputs an index associated with the angle at which the other vehicle travels with respect to the target lane. The other-vehicle heading direction index may be a numerical number, code, or score assigned according to the angle at which the other vehicle travels with respect to the target lane.

The other-vehicle comprehensive driving intention determination module 218 finally outputs the target lane that the other vehicle intends to enter as a result of comprehensive consideration of the indexes output from the above-described five sub-modules.

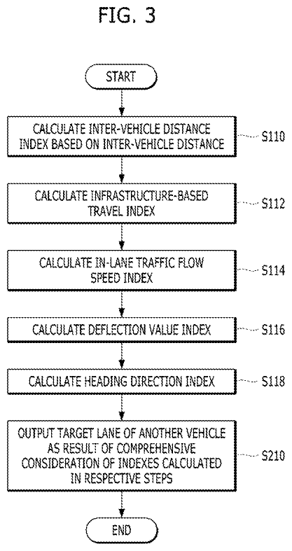

FIG. 3 is a control flowchart of the other-vehicle determiner 200 according to an embodiment of the present invention.

The other-vehicle determiner 200 may receive the information on the objects that have been fused onto the precise map, output from the driving environment determiner 120, and may determine the driving intention of another vehicle.

To this end, the other-vehicle determiner 200 outputs an inter-vehicle distance index based on an inter-vehicle distance (S110).

The other-vehicle determiner 200 determines and outputs a travel index of a vehicle based on infrastructure such as the current traffic signal, the remaining time, the next traffic signal (when V2X is available), and a road marking such as a bus stop or a school zone (S112).

The other-vehicle determiner 200 converts a traffic flow speed in a corresponding lane into an index based on the speed of the vehicle traveling in each lane, and outputs the index (S114).

The other-vehicle determiner 200 outputs an index associated with the degree of deflective travel of the other vehicle with respect to the center of the lane in which the other vehicle is traveling (S116).

The other-vehicle determiner 200 outputs an index associated with the angle at which the other vehicle travels with respect to the target lane (S118).

The other-vehicle determiner 200 finally outputs the target lane that the other vehicle intends to enter as a result of comprehensive consideration of the indexes calculated in the above steps (S210).

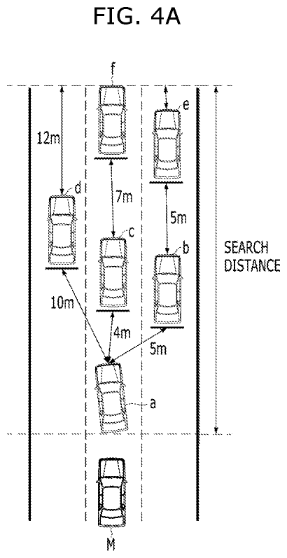

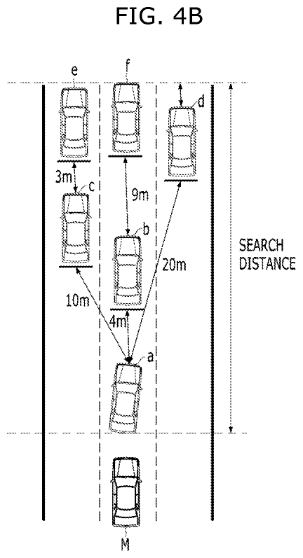

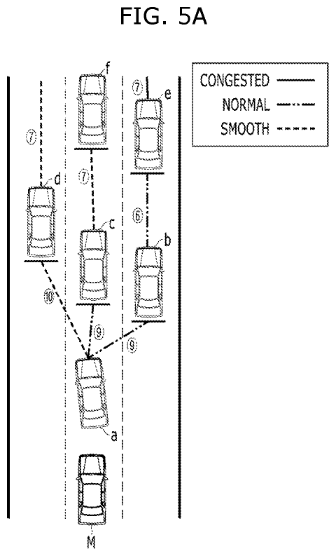

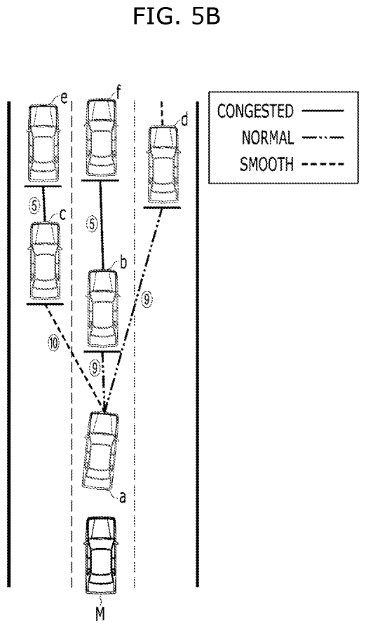

FIGS. 4A, 4B, 5A, and 5B are diagrams for explaining an in-lane extra space determination method according to an embodiment of the present invention. In order to determine the driving strategy of the host vehicle M, it is necessary to predict the driving intention of a vehicle a, which travels ahead of the host vehicle M in the driving lane of the host vehicle M. In order to predict the driving route of the driving intention determination target vehicle a, the in-lane extra space determination module 210 of the other-vehicle determiner 200 may output an index according to the in-lane extra space.

FIGS. 4A and 4B illustrate the extra space in each lane in different situations. As the distance between vehicles that are traveling increases, the probability of accelerating or driving at a constant speed to reduce the inter-vehicle distance increases. This probability may act as a factor increasing the average speed in the corresponding lane, and may act as a factor increasing the probability that the driving intention determination target vehicle a will select the corresponding lane.

The in-lane extra space may be calculated within a preset search distance based on the driving intention determination target vehicle a, which is present ahead of the host vehicle M. The in-lane extra space may be measured as the distances between the front end of the driving intention determination target vehicle a and the rear ends of other vehicles b, c and d, which are present ahead of the target vehicle a, and the distances between the front ends of the other vehicles b, c and d and the rear ends of other vehicles e and f, which are present ahead of the other vehicles b, c and d. The in-lane extra space may be calculated as the sum of respective in-lane extra spaces. Since the in-lane extra space corresponds to the distance between vehicles, excluding the length of the body of each vehicle, the sum of the inter-vehicle distances in the lane decreases as the number of vehicles traveling in the corresponding lane increases. The sum of the inter-vehicle distances in the lane increases as the number of vehicles traveling in the corresponding lane decreases. If there is no vehicle in the lane, the overall search distance may be determined to be the inter-vehicle distance.

The in-lane extra space determined in the above-described way is also associated with the degree of congestion of vehicles. The in-lane extra space may be replaced with the number of vehicles per predetermined distance (e.g. number/km), and may be used when calculating the index.

FIGS. 5A and 5B illustrate a method of assigning the index according to the speed of each vehicle in different situations.

In order to consider the speed factor that has the greatest influence on the traffic flow in each lane, a weight may be set according to the speed even if the same extra space is measured in different lanes. In general, as the speeds of a preceding vehicle c, which is traveling directly ahead of the driving intention determination target vehicle a in the same lane, and preceding vehicles b and d traveling in neighboring lanes are higher, it is easier to follow the vehicles, and as the speeds of the vehicles c, b and d are lower, it is less easy to follow the vehicles. Accordingly, the index may be assigned according to the speed of each vehicle in a manner such that a higher weight is set as the speed is higher.

The degree of interest may be lowered with respect to vehicles that are traveling ahead of the preceding vehicles c, b and d, which are traveling directly ahead of the driving intention determination target vehicle a. Accordingly, a weight may be set differently according to the ordinal number of the position of a vehicle, counting from the driving intention determination target vehicle a in the forward direction.

Accordingly, as the speed of another vehicle is higher and the distance from the driving intention determination target vehicle a is shorter, a higher weight may be assigned to the other vehicle. For example, as shown in FIGS. 5A and 5B, according to the traffic flow, 8 to 10 points may be assigned to the preceding vehicles b, c and d, which are traveling directly ahead of the driving intention determination target vehicle a, 5 to 7 points may be assigned to vehicles e and f, which are traveling ahead of the preceding vehicles b, c and d, and 2 to 4 points may be assigned to vehicles (not shown), which are traveling ahead of the vehicles e and f.

However, when a vehicle such as a bus or a taxi decelerates ahead of the driving intention determination target vehicle a in the outermost lane, the likelihood of this vehicle stopping is higher than the likelihood of the same decelerating for general reasons. Accordingly, a higher weight may be set depending on the type of vehicle.

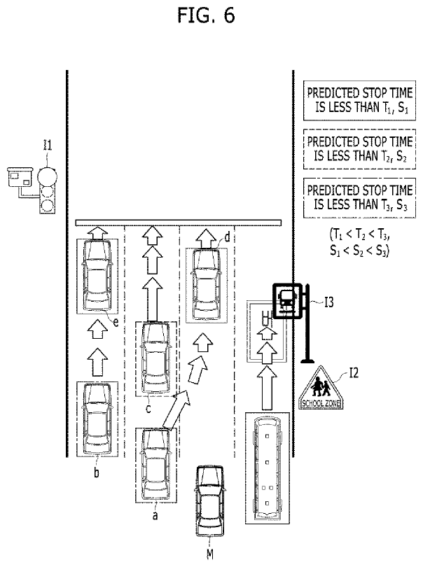

FIG. 6 is a diagram for explaining an infrastructure-based determination method according to an embodiment of the present invention.

In general, when approaching a traffic light at an intersection, vehicles tend to travel while changing the driving strategies thereof depending on the state of the traffic signal. For example, in the case in which the traffic light ahead of the host vehicle is a green light and the remaining time is 3 seconds, even if it is predicted that the host vehicle will pass through the intersection in 3 seconds based on the predicted driving routes of other vehicles, this prediction may differ from the actual travel of the host vehicle. Therefore, it is necessary to predict the driving intention of other vehicles using information on infrastructure such as a traffic signal I1, a school zone I2, and a bus stop I3.

It is illustrated in FIG. 6 that the index assignment method is simplified to three stages such that the indexes of other vehicles having predicted stop times T1, T2 and T3 (T1<T2 <T3) are set to S1, S2 and S3 points (S1<S2<S3), respectively. However, the index assignment method may be implemented in any of various other manners.

In addition, a higher index is assigned to a location or a section where other vehicles travel more smoothly, thereby making it possible to more accurately predict the future driving state of the other vehicles when determining the driving intention thereof.

On the other hand, when it is predicted that other vehicles travel slowly due to a stop signal, a school zone, or a bus stop, a low index may be assigned to the driving intention of the other vehicles based thereon.

In general, since the shoulder or the outermost lane of a road is an area in which parking and stopping of vehicles frequently occur, many general drivers tend to reduce the speeds of their vehicles to an average travel speed when driving in the corresponding lane, so a relatively low index may be applied to the corresponding lane.

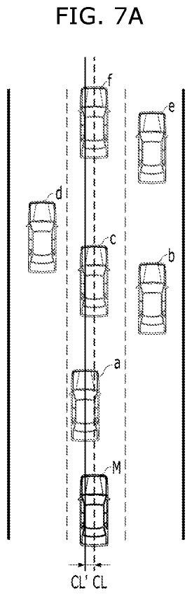

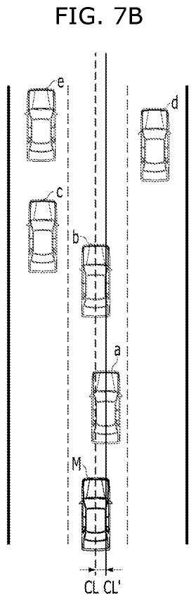

FIGS. 7A and 7B are diagrams for explaining an other-vehicle deflection value determination method according to an embodiment of the present invention.

FIG. 7A illustrates the case in which the center line CL′ of the driving intention determination target vehicle a is deflected to the left from the center line CL of the driving lane of the host vehicle M, and FIG. 7B illustrates the case in which the center line CL′ of the driving intention determination target vehicle a is deflected to the right from the center line CL of the driving lane of the host vehicle M.

As shown in FIG. 7A, when the driving intention determination target vehicle a is in the state of being deflected to the left, the time taken for the same to enter the right lane may be increased, but the time taken to enter the left lane may be decreased. In general, vehicles tend to travel in the state of being deflected toward an area close to a target lane before entering the target lane for the economic reason that the time taken for the same to enter the target lane is shortened. Accordingly, the driving intention index associated with a lane change may be increased with respect to a lane toward which the driving intention determination target vehicle a is deflected in proportion to the deflection value thereof.

Even when the driving intention determination target vehicle a enters the lane in the opposite direction from the lane toward which the driving intention determination target vehicle a has been deflected, the driving intention thereof is re-calculated every frame based on the real-time deflection value, whereby the latest deflection information may be used to determine the updated driving intention.

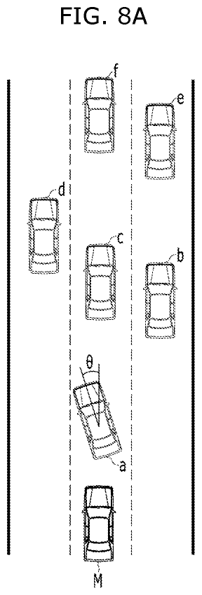

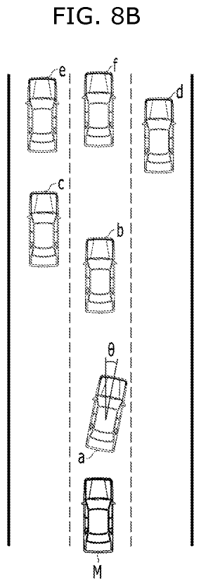

FIGS. 8A and 8B are diagrams for explaining an other-vehicle heading direction determination method according to an embodiment of the present invention.

FIG. 8A illustrates the case in which the body of the driving intention determination target vehicle a is deflected to the left with respect to the center line of the driving lane of the host vehicle M, and FIG. 8B illustrates the case in which the body of the driving intention determination target vehicle a is deflected to the right with respect to the center line of the driving lane of the host vehicle M.

As the heading direction of the driving intention determination target vehicle a is oriented toward the left lane at a greater angle, the time taken for the same to enter the right lane may be increased, but the time taken to enter the left lane may be decreased. In general, vehicles tend to head toward a target lane before entering the target lane for the economic reason that the time taken for the same to enter the target lane is shortened.

Accordingly, indexes A, B and C may be set according to the angle θ at which the driving intention determination target vehicle a travels toward a target lane with respect to the center line of the driving lane. Here, the values of the indexes A, B and C and the curve shape of the (2n+1)-order (n∈N) graph may be set as tuning parameters.

For example, the driving intention index associated with a lane change may be increased in proportion to the angle +θ at which the driving intention determination target vehicle a travels toward a target lane. Even when the driving intention determination target vehicle a enters the lane in the opposite direction from the lane toward which the driving intention determination target vehicle a has been heading at an angle −θ, the driving intention thereof is re-calculated every frame based on the real-time heading direction, whereby the latest deflection information may be used to determine the updated driving intention.

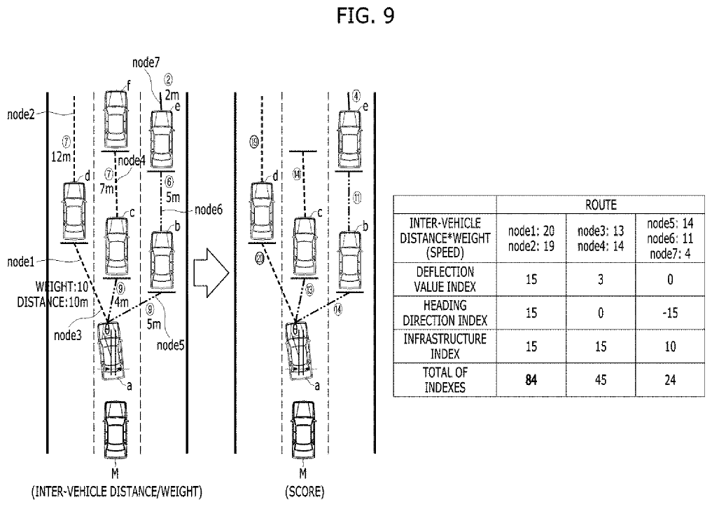

FIGS. 9 to 12 are diagrams for explaining a method of determining the driving intention of other vehicles according to an embodiment of the present invention.

The first diagram in FIG. 9 illustrates in-lane extra space and weight setting, the second diagram in FIG. 9 illustrates conversion of an index according to the in-lane extra space and the weight, and the third table in FIG. 9 illustrates a method of calculating the total score of the index according to the in-lane extra space and the weight, the index according to the deflection value, the index according to the heading angle, and the index according to the infrastructure.

Referring to the first diagram in FIG. 9, the in-lane extra space may be measured within a preset search distance from the driving intention determination target vehicle a. A weight may be applied to the in-lane extra space, and may be converted into an index. The weight may be assigned according to the speed of a vehicle and the ordinal number of the position of a vehicle, counting from the driving intention determination target vehicle a in the forward direction.

According to the traffic flow, weights of 8 to 10 points may be assigned to the vehicles b, c and d, which are closest to the driving intention determination target vehicle a, weights of 5 to 7 points may be assigned to the vehicles e and f, which are the second closest to the driving intention determination target vehicle a, and weights of 2 to 4 points may be assigned to vehicles that are present ahead of the vehicles e and f. Alternatively, if there is no vehicle ahead, the extra space may be determined to be a space until the end of the search area, and weights of 2 to 4 points may be assigned to the extra space. A weight may be applied to the extra space between vehicles, and may be converted into an index, as shown in the second diagram in FIG. 9.

For example, when the route from the driving intention determination target vehicle a to the vehicle c present directly ahead of the driving intention determination target vehicle a in the same lane is referred to as “node 3” and when the extra space therebetween is measured to be 4 m, the weight according to the speed and the position may be set to 9. In this case, the index of node 3 may be set to 13 points.

When the route from the driving intention determination target vehicle a to the vehicle b present ahead of the driving intention determination target vehicle a in the right lane is referred to as “node 5” and when the extra space therebetween is measured to be 5 m, the weight according to the speed and the position may be set to 9. In this case, the index of node 5 may be set to 14 points.

When the route from the driving intention determination target vehicle a to the vehicle d present ahead of the driving intention determination target vehicle a in the left lane is referred to as “node 1” and when the extra space therebetween is measured to be 10 m, the weight according to the speed and the position may be set to 10. In this case, the index of node 1 may be set to 20 points.

When the route from the vehicle c to the vehicle f present ahead of the vehicle c is referred to as “node 4” and when the extra space therebetween is measured to be 7 m, the weight according to the speed and the position may be set to 7. In this case, the index of node 4 may be set to 14 points.

When the route from the vehicle b to the vehicle e present ahead of the vehicle b is referred to as “node 6” and when the extra space therebetween is measured to be 5 m, the weight according to the speed and the position may be set to 6. In this case, the index of node 6 may be set to 11 points.

When there is no vehicle ahead of the vehicle d and thus the route to the end of the search area is referred to as “node 2” and when the extra space therebetween is measured to be 12 m, the weight according to the speed and the position may be set to 7. In this case, the index of node 2 may be set to 19 points.

When there is no vehicle ahead of the vehicle e and thus the route to the end of the search area is referred to as “node 7” and when the extra space therebetween is measured to be 2 m, the weight according to the speed and the position may be set to 2. In this case, the index of node 7 may be set to 4 points.

Referring to the table in FIG. 9, the total score of the index according to the in-lane extra space and the weight, the index according to the deflection value, the index according to the heading angle, and the index according to the infrastructure may be calculated in order to determine the driving intention of the driving intention determination target vehicle a.

The index used to determine the driving intention may be calculated based on the route along which the driving intention determination target vehicle a is expected to travel, i.e. the case of remaining in the current lane (node 3 and node 4), the case of changing to the left lane (node 1 and node 2), or the case of changing to the right lane (node 5 and node 6).

When the driving intention determination target vehicle a is expected to change from the current lane to the left lane, the indexes of node 1 and node 2 may be used. In addition, because the center line CL′ of the driving intention determination target vehicle a is deflected to the left from the center line CL of the driving lane, the deflection value index may be set to 15 points. In addition, the heading direction index may be set to 15 points according to the heading angle +θ at which the body of the driving intention determination target vehicle a is deflected with respect to the center line of the driving lane. The infrastructure index may be set to 15 points according to information on infrastructure such as a traffic signal or a bus stop.

When the driving intention determination target vehicle a is expected to remain in the current lane, the indexes of node 3 and node 4 may be used. In addition, because the center line CL′ of the driving intention determination target vehicle a is deflected to the left from the center line CL of the driving lane, the deflection value index may be set to 3 points. In addition, the heading direction index may be set to 0 points according to the heading angle +θ at which the body of the driving intention determination target vehicle a is deflected with respect to the center line of the driving lane. The infrastructure index may be set to 15 points according to information on infrastructure such as a traffic signal or a bus stop.

When the driving intention determination target vehicle a is expected to change from the current lane to the right lane, the indexes of node 5, node 6, and node 7 may be used. In addition, because the center line CL′ of the driving intention determination target vehicle a is deflected to the left from the center line CL of the driving lane, the deflection value index may be set to 0 points due to the lane change to the right lane. In addition, the heading direction index may be set to −15 points according to the heading angle +θ at which the body of the driving intention determination target vehicle a is deflected with respect to the center line of the driving lane. The infrastructure index may be set to 10 points according to information on infrastructure such as a traffic signal or a bus stop.

When the driving intention determination target vehicle a is expected to change from the current lane to the left lane, the total score of the indexes calculated as described above is 84. When the driving intention determination target vehicle a is expected to remain in the current lane, the total score of the indexes calculated as described above is 45. When the driving intention determination target vehicle a is expected to change from the current lane to the right lane, the total score of the indexes calculated as described above is 24. As a result, it can be determined that the probability of changing from the current lane to the left lane, to which the highest total score is assigned, is the highest.

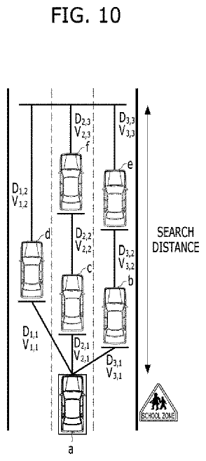

FIG. 10 is a diagram for explaining a method of programming an equation for calculating the total score according to the index calculation method shown in FIG. 9.

“Dnn/Vnn” described in FIG. 10 is a mathematical representation of the distance and the traffic flow between the driving intention determination target vehicle a and each of the other vehicles b, c, d, e and f. The indexes, into which the distance and the traffic flow between the driving intention determination target vehicle a and each of the other vehicles b, c, d, e and f are mathematically converted, may be substituted into the following equation 1 to calculate the final total score.

D_{(LaneNum),N}: Score of distance between N^{th} vehicle and (N−1)^{th} vehicle in (LaneNum)^{th} lane

V_{(LaneNum),N}: Score of traffic flow of N^{th} vehicle in (LaneNum)^{th} lane

I_{(LaneNum)}: Score of travel of another vehicle in (LaneNum)^{th} lane with respect to infrastructure

B_{LaneNum}: Score of deflection value of another vehicle with respect to (LaneNum)^{th} lane

H_{LaneNum}(θ): Score of heading angle of another vehicle with respect to (LaneNum)^{th} lane

W_{D}, W_{V}, W_{B}, W_{H}, W_{I}: weights with respect to above scores

$$DefChooseNextLane ( {D}_{( LaneNum ) , N} , {w}_{( LaneNum ) , N} , {B}_{LaneNum} , {H}_{LaneNum} ) : {S}_{LaneNum , Total} = ( {\sum }_{N} {D}_{LaneNum , N} ) * {w}_{D} + ( {\sum }_{N} {V}_{LaneNum , N} ) * {w}_{v} + {I}_{LaneNum} * {w}_{I} + {B}_{LaneNum} * {w}_{B} + {H}_{LaneNum} ( θ ) * {w}_{H} \\ NextLaneNum = {argmax}_{LaneNum} ( {S}_{LaneNum , Total} ) \\ If ( NextLaneNum ) != ( LaneNum ) : // Prediction of Lane Change of Another Vehicle \\ if CheckTTC ( ) == True : \\ return NextLaneNum \\ else : \\ return 0 \qquad Equation 1$$

Here, when the value of “NextLaneNum” is determined to be high enough to cause a collision based on the time to collision (TTC), it can be finally determined that the driving intention determination target vehicle a will not change lanes.

The driving intention of all of the vehicles present ahead of the host vehicle in the left lane, the right lane, and the same lane may be predicted using the driving intention prediction method described above, thereby making it possible to determine the driving route of each vehicle at the next time point.

When another vehicle is expected to remain in the current lane, PID control of the distance to the front tracking point may be performed. When another vehicle is expected to change lanes, the driving strategy of the host vehicle for responding to lane change to a corresponding lane link needs to be determined. When the time required to change lanes is T, the corresponding vehicle can be regarded to be located in “NextLane” in T seconds. That is, the position is changed according to the expected lane change route.

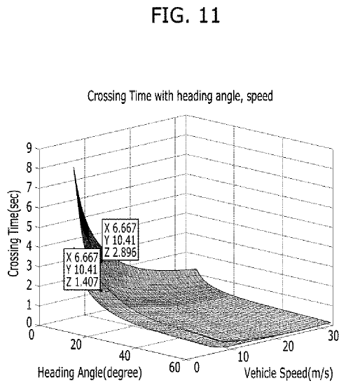

The required time T may greatly depend on the heading direction, the current speed, and the deflection value of another vehicle, and may be calculated as an appropriate value through interpolation based on a table of the values calculated in advance, as shown in FIG. 11, or through mathematical modeling.

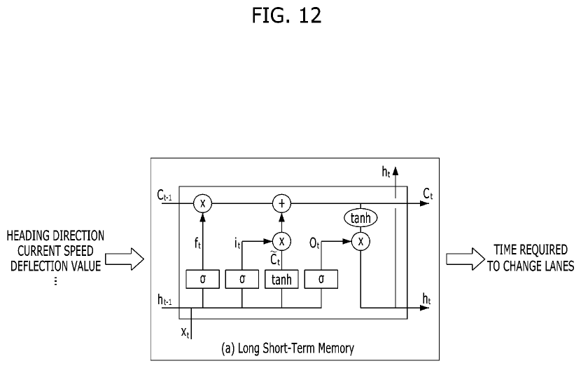

Alternatively, as shown in FIG. 12, it may be possible to calculate the required time by learning the above parameters based on deep-learning parameters and using a time-series prediction method such as LSTM or CNN.

Finally, the driving intention of another vehicle may be composed of a target lane and a time point at which the other vehicle is located in the target lane. Also, the driving intention of another vehicle and the time required to change lanes may be calculated as reliable data through one-shot determination and N-sample observation.

FIGS. 11 and 12 illustrate calculation methods that can be used when predicting the driving intention of another vehicle according to an embodiment of the present invention.

FIG. 11 shows the results of modeling the required time according to the heading direction and the vehicle speed using a mesh plot when the deflection values of the driving intention determination target vehicle a are 0.8 m and 0. A constant-speed lane change model may be calculated using a required time plot or a third-order poly route model.

FIG. 12 is a diagram schematically illustrating an embodiment in which input data, such as a heading direction, a current speed, and a deflection value, is processed based on deep learning to calculate the time required for another vehicle to change lanes.

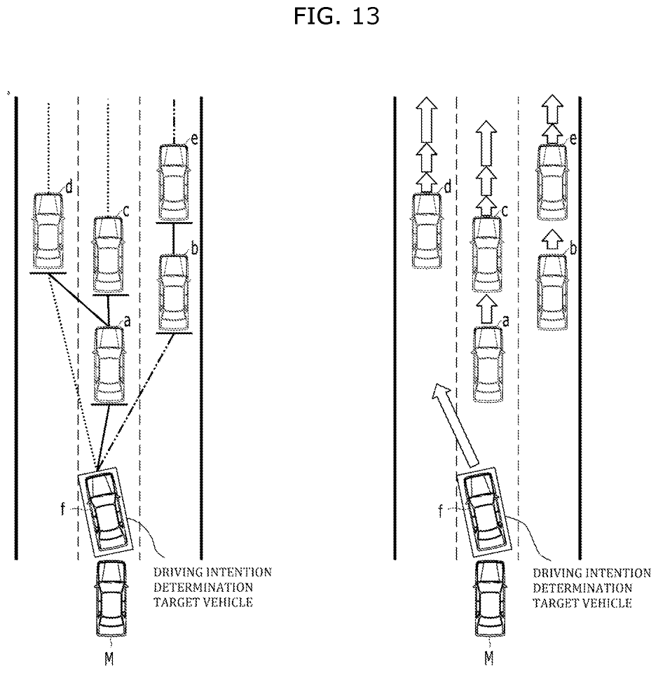

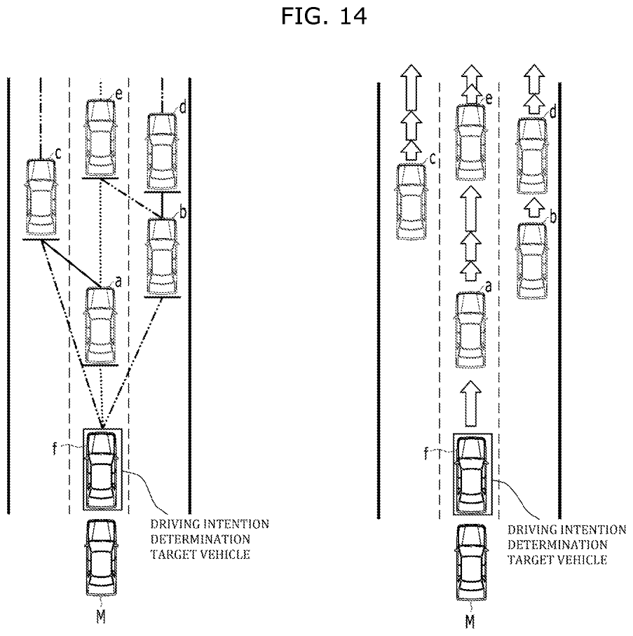

FIGS. 13 and 14 are diagrams for explaining a method of controlling the host vehicle based on the driving intention of another vehicle according to an embodiment of the present invention.

FIGS. 13 and 14 are diagrams for explaining a method of changing the strategy of the host vehicle according to an embodiment of the present invention. Specifically, FIG. 13 illustrates a method of controlling driving of the host vehicle in an event of a lane change of a preceding vehicle to a left lane, and FIG. 14 illustrates a method of controlling driving of the host vehicle in an event that a preceding vehicle remains in the same lane.

Referring to FIG. 13, a vehicle A traveling directly ahead of the host vehicle M may be a driving intention determination target vehicle. When it is determined that the distance between vehicles in the left lane is long, that the traffic flow in the left lane is smooth, and that the driving intention determination target vehicle A moves to the left, it can be predicted that the corresponding vehicle A will change to the left lane.

Therefore, the host vehicle M may be controlled to remain in the current lane or to change to the right lane.

Referring to FIG. 14, a vehicle A traveling directly ahead of the host vehicle M may be a driving intention determination target vehicle. When it is determined that the distance between vehicles in the lane in which the host vehicle M is traveling is not short or long, that the traffic flow in the corresponding lane is smooth, and that the driving intention determination target vehicle A is in a normal driving state, it can be predicted that the corresponding vehicle A will remain in the current lane.

Therefore, the host vehicle M may be controlled to remain in the current lane or to change to the left lane, in which the distance between vehicles is longer.

As described above, embodiments of the present invention are capable of predicting the routes of other vehicles present in the search area based on the distance between neighboring vehicles, the driving intention of the neighboring vehicles, the vehicle speed, the presence or absence of a dangerous vehicle, and surrounding infrastructure and of determining the driving route of a host vehicle based on the predicted routes of the other vehicles, thereby making it possible to respond to a preceding vehicle that changes lanes and to maintain an optimal driving state in various traffic environments, for example, a complicated traffic situation in which two or more vehicles change lanes at the same time.

In particular, embodiments of the present invention select the vehicle that is closest to the host vehicle in the same lane as a vehicle of interest, analyze the distance between other vehicles present in the search area of the vehicle of interest, the traffic flow thereof, the dynamic characteristics thereof, and infrastructure information, and determine the driving intention of the vehicles based on the interaction between the vehicles, thereby making it possible to improve accuracy of prediction of the driving routes of the other vehicles including the vehicle of interest.

In addition, it is possible to reduce the occurrence of false alarms and alarm failure by variably applying a risk determination criterion in consideration of the driving intention of another vehicle and to reduce the occurrence of stopping or deceleration, which may occur due to non-consideration of the future position of the other vehicle, thereby improving riding comfort.

As is apparent from the above description, an autonomous driving control apparatus and method according to at least one embodiment of the present invention configured as described above may improve the accuracy of prediction of a driving route of a neighboring vehicle in various traffic environments.

In particular, embodiments of the present invention may predict the driving routes of neighboring vehicles through analysis of the distance between other vehicles present in a search area, the traffic flow thereof, the dynamic characteristics thereof, and infrastructure information and through determination of the driving intention of the vehicles based on the interaction between the vehicles.

In addition, embodiments of the present invention may reduce the occurrence of false alarms and alarm failure by variably applying a risk determination criterion in consideration of the driving intention of another vehicle, and may reduce the occurrence of stopping or deceleration, which may occur due to non-consideration of the future position of the other vehicle, thereby improving riding comfort.

However, the effects achievable through embodiments of the present invention are not limited to the above-mentioned effects, and other effects not mentioned herein will be clearly understood by those skilled in the art from the above description.

Embodiments of the present invention may be implemented as code that can be written on a computer-readable recording medium and thus read by a computer system. The computer-readable recording medium includes all kinds of recording devices in which data that may be read by a computer system are stored. Examples of the computer-readable recording medium include a Hard Disk Drive (HDD), a Solid-State Disk (SSD), a Silicon Disk Drive (SDD), Read-Only Memory (ROM), Random Access Memory (RAM), Compact Disk ROM (CD-ROM), a magnetic tape, a floppy disc, and an optical data storage.

It will be apparent to those skilled in the art that various changes in form and details may be made without departing from the spirit and essential characteristics of embodiments of the invention set forth herein. Accordingly, the above detailed description is not intended to be construed to limit the invention in all aspects and is to be considered by way of example. The scope of the invention should be determined by reasonable interpretation of the appended claims and all equivalent modifications made without departing from the invention should be included in the following claims.

What is claimed is:

1. An autonomous driving control method, the method comprising:
collecting travel information on a host vehicle traveling autonomously and on at least one other vehicle;
determining a driving intention of the other vehicle based on the travel information on the other vehicle;
predicting a driving route of the other vehicle based on the driving intention of the other vehicle; and
determining a driving route of the host vehicle based on the predicted driving route of the other vehicle.

2. The method according to claim 1, wherein the travel information comprises at least one of position information on the host vehicle and the other vehicle, speed information on the host vehicle and the other vehicle, acceleration information on the host vehicle and the other vehicle, deflection angle information on the other vehicle, heading angle information on the other vehicle, precise map information, or information on infrastructure comprising a traffic light, a bus stop, and a school zone.

3. The method according to claim 1, wherein determining the driving intention of the other vehicle comprises predicting a lane that the other vehicle intends to enter based on a result of applying a predetermined index to the travel information on the other vehicle.

4. The method according to claim 3, wherein:
determining the driving intention of the other vehicle comprises determining a driving intention of a vehicle of interest traveling directly ahead of the host vehicle in a same lane as the host vehicle; and
wherein determining the driving intention of the vehicle of interest comprises predicting a lane that the vehicle of interest intends to enter based on at least one of position information and speed information on the vehicle of interest and other vehicles, deflection value information on the vehicle of interest, or heading direction information on the vehicle of interest.

5. The method according to claim 4, wherein determining the driving intention of the vehicle of interest comprises:
calculating an index associated with an in-lane extra space based on a distance between the vehicle of interest and another vehicle;
calculating an index associated with travel states of vehicles based on information on infrastructure;
calculating an index associated with a speed of a vehicle in each lane;
calculating an index associated with a degree of deflection of the vehicle of interest with respect to a center of a lane in which the vehicle of interest is traveling;
calculating an index associated with a heading angle of the vehicle of interest; and
predicting a lane that the vehicle of interest intends to enter through comprehensive determination of calculated indexes.

6. The method according to claim 5, wherein calculating the index associated with the in-lane extra space comprises:
measuring a distance between the vehicle of interest and the another vehicle;
applying a predetermined weight according to a speed of the another vehicle; and
applying a predetermined weight according to an ordinal number of a position of the another vehicle, counting from the vehicle of interest in a forward direction.

7. The method according to claim 6, wherein, as the speed of the another vehicle goes higher, a higher weight is applied, and as the another vehicle moves closer to the vehicle of interest, a higher weight is applied.

8. The method according to claim 5, wherein calculating the index associated with the travel states of the vehicles based on the information on the infrastructure comprises calculating a lower index as a probability of reducing a speed of one of the vehicles is higher.

9. The method according to claim 5, wherein calculating the index associated with the degree of deflection of the vehicle of interest with respect to the center of the lane in which the vehicle of interest is traveling comprises applying a higher index to a lane toward which the vehicle of interest is deflected.

10. The method according to claim 5, wherein calculating the index associated with the heading angle of the vehicle of interest comprises applying a higher index to a lane toward which the vehicle of interest travels at a larger heading angle with respect to a center line of the vehicle of interest.

11. The method according to claim 5, further comprising predicting a lane in which a total score of the calculated indexes is largest to be a lane that the vehicle of interest intends to enter.

12. A non-transitory computer-readable recording medium having recorded thereon a program for executing the method of claim 1.

13. An autonomous driving control apparatus, the apparatus comprising:
a first determiner configured to collect travel information on a host vehicle traveling autonomously and on at least one other vehicle present near the host vehicle to determine a traffic environment;
a second determiner configured to determine a driving intention of a vehicle of interest traveling directly ahead of the host vehicle in a same lane as the host vehicle based on the travel information on the other vehicle; and
a driving controller configured to predict a driving route of the other vehicle based on a driving intention of the other vehicle and the travel information on the other vehicle and to determine a driving route of the host vehicle based on the predicted driving route of the other vehicle.

14. The apparatus according to claim 13, wherein the travel information comprises at least one of position information on the host vehicle and the other vehicle, speed information on the host vehicle and the other vehicle, acceleration information on the host vehicle and the other vehicle, deflection angle information on the other vehicle, heading angle information on the other vehicle, precise map information, or information on infrastructure comprising a traffic light, a bus stop, and a school zone.

15. The apparatus according to claim 14, wherein the second determiner comprises:
an in-lane extra space determination module configured to calculate an index associated with an in-lane extra space based on a distance between the vehicle of interest and the other vehicle based on a result of determination by the first determiner;
an infrastructure-based determination module configured to calculate an index associated with travel states of vehicles based on the information on the infrastructure;
an in-lane traffic flow determination module configured to calculate an index associated with a speed of a vehicle in each lane;
an other-vehicle deflection value determination module configured to calculate an index associated with a degree of deflection of the vehicle of interest with respect to a center of a lane in which the vehicle of interest is traveling;
an other-vehicle heading direction determination module configured to calculate an index associated with a heading angle of the vehicle of interest; and
an other-vehicle driving intention determination module configured to predict a lane that the vehicle of interest intends to enter through comprehensive determination of calculated indexes.

16. The apparatus according to claim 15, wherein the in-lane extra space determination module is configured to measure a distance between the vehicle of interest and another vehicle, apply a predetermined weight according to a speed of the another vehicle, and apply a predetermined weight according to an ordinal number of a position of the another vehicle, counting from the vehicle of interest in a forward direction, to calculate the index associated with the in-lane extra space.

17. The apparatus according to claim 15, wherein the infrastructure-based determination module is configured to calculate, based on the information on the infrastructure, a lower index as a probability that a speed of the other vehicle is reduced by the infrastructure is higher.

18. The apparatus according to claim 15, wherein the other-vehicle deflection value determination module is configured to apply a higher index to a lane toward which the vehicle of interest is deflected with respect to a center of a lane in which the vehicle of interest is traveling.

19. The apparatus according to claim 15, wherein the other-vehicle heading direction determination module is configured to apply a higher index to a lane toward which the vehicle of interest travels at a larger heading angle with respect to a center line of the vehicle of interest.
